(19) United States
(12) Patent Application Publication
(10) Pub. No.: US 2014/0060482 A1
(43) Pub. Date: Mar. 6, 2014

(54) Six Stroke 'Blackburn Cycle' Engine

(71) Applicant: Anthony Edgar Blackburn, (US)

(72) Inventor: Anthony Edgar Blackburn, (US)

(21) Appl. No.: 13/602,110

(22) Filed: Sep. 1, 2012

(51) Int. Cl. F01L 1/04; F02B 17/00

(52) U.S. Cl. 123/294; 123/90.15

(57) ABSTRACT

A ‘Blackburn Cycle’ internal combustion engine has maximised ‘air only’ induction and ‘air only’ exhaust strokes between usual 4 stroke cycles. One or more inlet valves open fully via lever 7 for the alternate ‘air only’ inductions. The travel for the next fuel/air induction through the same inlet valve 13 is varied by variable fulcrum 10 acting on rocker 8 via push rod 11. This gives controllable fuel/air inductions without the need for a throttle. An inlet valve opens twice with one cam form and one cam revolution. Fuel is injected directly into the cylinder as required for the usual 4 stroke cycles between the ‘air only’ cycles.

### BACKGROUND

Blackburn Cycle' engines have ‘air only’ inductions between usual fuel/air combustion cycles and aim to increase the fuel efficiency and reduce the CO2 emissions from internal combustion engines particularly when used at low loads.

Previous versions of the ‘Blackburn Cycle’ had 8 strokes as follows :—1 Fuel/air induction, 2 Compression, 3 Power, 4 Exhaust, 5 ‘Air only’ induction, 6 ‘Air only’ compression, 7 ‘Air only’ expansion, 8 ‘Air only’ exhaust. This leaves a residue of ‘air only’ to be mixed with the fresh fuel/air induction. An ideal explosive charge is created free from exhaust gas which increases fuel efficiency. The cycle also reduces the charge temperature at the start of the cycle, increases the combustion temperature and pressure and gives other advantages. This 8 stroke cycle is easily changed to a usual 4 stroke cycle when high power is needed.

Combustion conditions can also be improved with the present invention by introducing ‘air only’ induction and exhaust strokes between usual 4 stroke cycles making a Six Stroke ‘Blackburn Cycle’. However, it is more difficult, but not impossible, to change this cycle to 4 stroke for high power.

### DESCRIPTION

There is provided a ‘Blackburn Cycle’ internal combustion engine where ‘air only’ inductions occur between usual fuel/air 4 stroke cycles to create the following cycle:—1 Variable fuel/air induction depending on the engine power required, 2 Compression, 3 Power, 4 Exhaust, 5 Maximised ‘air only’ induction, 6 ‘Air only’ exhaust, the cycle then repeats for each cylinder, one inlet cam opens an inlet valve, via a variable mechanism, for a variable fuel/air induction then the same cam opens the same inlet valve fully for a maximised ‘air only’ induction as stroke 5 above.

A power control shaft contains a variable fulcrum, with hydraulic adjustment, which acts on a rocker to transfer motion from a cam to an inlet valve, so as to vary the inlet valve opening for fuel/air inductions according to the engine power required. This rocker is located by a link, or other means, which is attached to the cylinder head.

An inlet valve opens twice with one rotation of one cam form on the inlet camshaft using two separate cam followers and linkages to the same inlet valve. The inlet and exhaust camshafts are driven at ⅓ crankshaft speed and each inlet cam open period is approximately 80 degrees of camshaft rotation. The inlet cam followers are set at approximately 120 degrees to each other relative to the camshaft centre.

The exhaust camshaft has two lobes, spaced at approximately 120 degrees, which opens an exhaust valve twice with one camshaft rotation and one cam follower. Fuel is injected directly into the engine cylinder with no fuel injection for the ‘air only’ inductions. Other mechanisms, not shown here, can use one camshaft for operating both inlet and exhaust valves. Port fuel injection is an alternative.

1080 degrees of crankshaft rotation are needed to complete the 6 stroke cycle on a single cylinder engine, 2 cylinders need 540 degrees of crankshaft rotation for equally spaced combustions , 3 cylinder 360 degrees, 4 cylinder 270 degrees, 5 cylinders 216 degrees and 6 cylinder 180 degrees etc.

Separate hydraulic adjustment is shown for the maximised ‘air only’ induction rocker and the exhaust rocker. A spring 15 prevents the variable rocker 8 moving when the inlet valve is opened by lower rocker 7.

A ‘Blackburn Cycle’ engine also uses a variable inlet valve mechanism as FIGS. 1:2 and 2:2 which is used to convert a 2 stroke cycle to a 4 stroke cycle with alternate ‘air only’ 2 stroke cycles between fuel/air 2 stroke cycles, when less than half load is needed. The inlet camshaft is then driven at 1:2 crankshaft speed and the exhaust camshaft at crankshaft speed, each with single cam lobes.

### DESCRIPTION OF THE DRAWINGS

FIG. 1:2 combines features of ‘Blackburn Cycle’ 8 stroke patents GB 2445415 and GB 2451448, while FIG. 2:2 modifies this layout to suit the current Six Stroke Blackburn Cycle' patent.

FIG. 1:2 shows a section through the nearest cam. Piston 1 is shown in cylinder 2 which is closed by cylinder head 3 which houses permanently engaged inlet valve lever 7 which maximises the ‘air only’ inductions. Camshaft 6, driven at 1:4 crankshaft speed, has a cam profile which opens the inlet valve 13 in inlet port 4 via lever 7. As camshaft 6 rotates further at 1:4 crankshaft speed, variable rocker 8 is moved by cam 6. Rocker 8 is located in position by link 9 which is fixed to the cylinder head 3. Variable fulcrum 10 is rotated a few degrees clockwise to increase the travel of inlet valve 13, or rotated a few degrees anticlockwise to reduce the opening of inlet valve 13. This eliminates the need for a throttle. The movement of rocker 8 is relayed to inlet valve 13 via pushrod 11 and a socket on lever 7. Fuel injection 14 is directly into the cylinder when required but no fuel injection for the ‘air only’ inductions. Spring 15 prevents variable rocker 8 moving as lever 7 opens an inlet valve.

FIG. 2:2 shows a section through the nearest cam for the current Six Stroke Blackburn Cycle' engine. The component parts are numbered as FIG. 1:2 above but have the following changes. Inlet cam 6 and exhaust cam 12 are both driven at 1:3 crankshaft speed. Exhaust cam 12 has two lobes which are set at approximately 120 degrees to each other while inlet cam 6 has one cam lobe but the fixed travel and variable travel cam followers are set at approximately 120 degrees to each other relative to the camshaft centre. The version for the current patent as FIG. 2:2 has no need for a throttle as the fuel/air intake can be varied by variable fulcrum 10, which is linked directly to an accelerator pedal or operated by a servo. This layout permits one, two or more inlet and exhaust valves per cylinder which is suitable for maximising the power/litre of engine capacity. Fuel injection 14 for this layout is directly into the cylinder when required. There is no fuel injection for the ‘air only’ inductions strokes.

1. There is provided a ‘Blackburn Cycle’ internal combustion engine where ‘air only’ inductions occur between usual fuel/air combustion cycles to create the following cycle:—1 Variable fuel/air induction depending on the engine power required, 2 Compression, 3 Power, 4 Exhaust, 5 Maximised ‘air only’ induction, 6 ‘Air only’ exhaust, the cycle then repeats for each cylinder, one inlet cam opens an inlet valve, via a variable mechanism, for a variable fuel/air induction then the same cam opens the same inlet valve fully for a maximised ‘air only’ induction as stroke 5 above.

2. A ‘Blackburn Cycle’ engine as claimed in claim 1 where a variable fulcrum acts on a rocker, which transfers motion from a cam to an inlet valve, so as to vary the inlet valve opening for fuel/air inductions according to the engine power required.

3. A ‘Blackburn Cycle’ engine as claimed in claim 1 where an inlet valve opens twice with one rotation of the inlet camshaft using separate cam followers and linkages to the same inlet valve.

4. A ‘Blackburn Cycle’ engine as claimed in claim 1 where the inlet and exhaust camshafts are driven at ⅓ crankshaft speed.

5. A ‘Blackburn Cycle’ engine as claimed in claim 1 where each inlet cam open period is approximately 80 degrees of camshaft rotation.

6. A ‘Blackburn Cycle’ engine as claimed in claim 1 where the separate inlet cam followers for the variable fuel/air and maximised ‘air only’ inductions are spaced at approximately 120 degrees relative to the camshaft centre

7. A ‘Blackburn Cycle’ engine as claimed in claim 1 where the exhaust cam has two lobes, spaced at approximately 120 degrees, relative to the camshaft centre, which opens an exhaust valve twice with one camshaft rotation and one cam follower.

8. A ‘Blackburn Cycle’ engine as claimed in claim 1 where fuel is injected directly into the engine cylinder.

9. A ‘Blackburn Cycle’ engine as claimed in claim 1 where 1080 degrees of crankshaft rotation are needed to complete the 6 stroke cycle on a single cylinder engine.

10. A ‘Blackburn Cycle’ engine as claimed in claim 1 where evenly spaced firing intervals on a 2 cylinder engine are at 540 degrees of crankshaft rotation , 3 cylinder 360 degrees, 4 cylinder 270 degrees, 5 cylinders 216 degrees and 6 cylinder 180 degrees etc.

11. A ‘Blackburn Cycle’ engine as claimed in claim 1 where automatic valve adjustment is provided in the form of an oil filled chamber fitted with a non return oil valve and a piston for the variable travel fuel/air induction rocker and separate hydraulic adjustment for the maximised ‘air only’ induction rocker.

12. A ‘Blackburn Cycle’ engine as claimed in claim 1 where a spring prevents the fuel/air variable rocker moving when the ‘air only’ rocker opens an inlet valve.

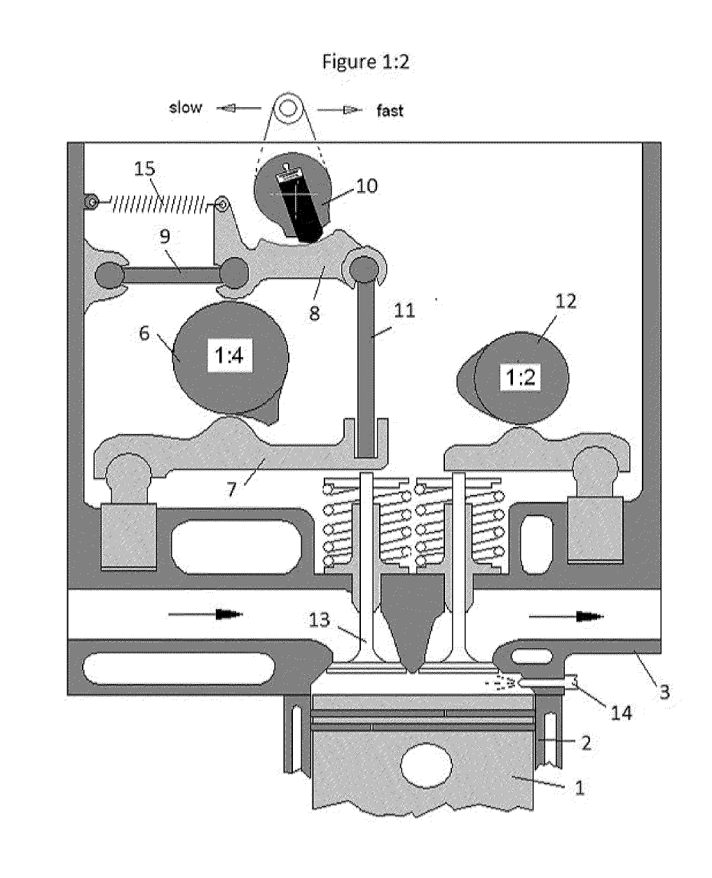

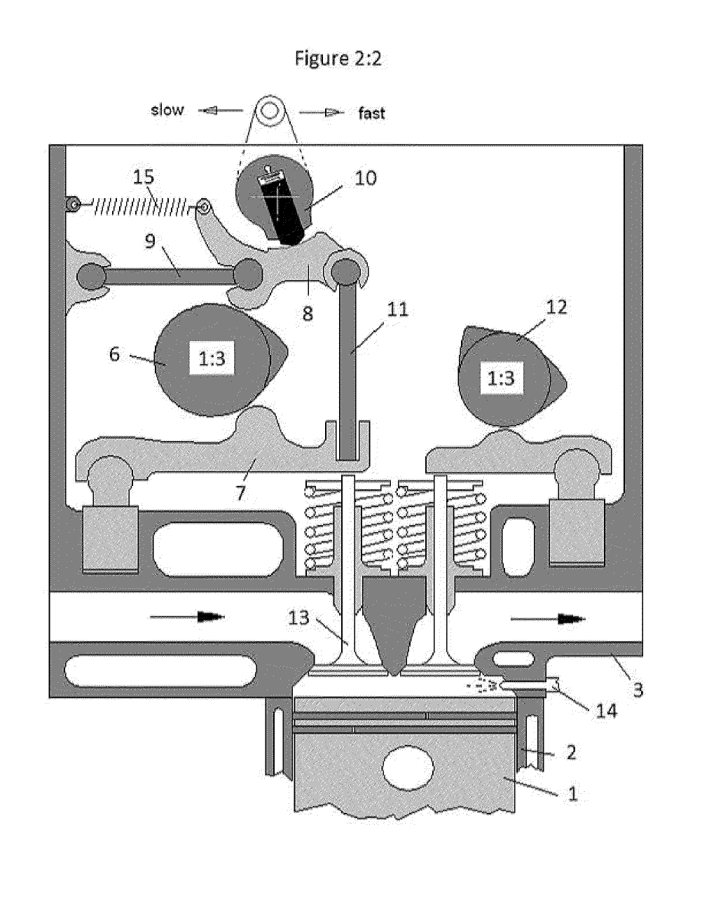

13. A ‘Blackburn Cycle’ engine with a variable inlet valve mechanism as FIGS. 1:2 and 2:2 which is used to convert a 2 stroke cycle engine to a 4 stroke cycle with alternate ‘air only’ 2 stroke cycles between fuel/air 2 stroke cycles, when less than half load is needed, the inlet camshaft is driven at 1:2 crankshaft speed and the exhaust camshaft at crankshaft speed, each with single cam lobes.

14. A ‘Blackburn Cycle’ engine as claimed in claim 1 where the rotation of the variable fulcrum is linked directly to an accelerator pedal or operated by a servo with or without electronic control.

15. An engine as described and as shown in FIGS. 1:2 and 2:2.
